(19) United States
(12) Patent Application Publication
(10) Pub. No.: US 2014/0319349 A1
(43) Pub. Date: Oct. 30, 2014

(54) MOTION DETECTION DEVICE

(71) Applicant: National University Corporation KOBE University, Kobe-shi, Hyogo (JP)

(72) Inventors: Satoshi Horie, Hyogo (JP); Kenji Ishida, Hyogo (JP); Yasukiyo Ueda, Hyogo (JP)

(21) Appl. No.: 14/360,458

(22) PCT Filed: Nov. 22, 2012
(86) PCT No.: PCT/JP2012/080305

§ 371 Date: May 23, 2014

(30) Foreign Application Priority Data
Nov. 23, 2011 (JP) 2011-255639

(51) Int. Cl. G01J 5/00

(52) U.S. Cl. CPC G01J 5/0025
USPC 250/338.3

(57) ABSTRACT

A motion detector comprising a substrate on a surface of which a plurality of pyroelectric elements for 5 detecting infrared light emitted from an object are placed at intervals, a detection circuit for converting an input signal from each pyroelectric element into a voltage signal to output the voltage signal, and a determination means for comparing the output signal of the detection circuit with a preset reference value to determine whether or not there is a motion of the object in detection regions that are set within 10 predetermined detection distances from the pyroelectric elements, wherein the output signal of the detection circuit is configured to be constant in a set frequency band, and the motion detector further comprises a movement information calculating means for calculating movement information containing information on a distance to the object and a direction of movement of the object determined by the 15 determination means.

### TECHNICAL FIELD

The present invention relates to a motion detector, and more specifically, relates to a motion detector for detecting the motion of an object such as a human body using pyroelectric elements.

### BACKGROUND ART

To date, motion detectors for detecting the presence or absence of motion of, for example, a human body as well as details of the motion using pyroelectric elements are known. For example, Patent Literatures 1 and 2 disclose a configuration for detecting motion of a finger or a hand to identify an instruction and performing an input operation on an electronic apparatus.

However, there is a possibility that conventional motion detectors such as those having the aforementioned configuration are not able to correctly detect motion because the size of an output signal changes due to not only the distance from the detection target such as a finger or a hand to the pyroelectric element but also the speed of motion.

Regarding the above problem, Patent Literature 3 provides an example as shown in FIG. 1(b) of the frequency response characteristics of an electric circuit as shown in FIG. 1(a). The circuit shown in FIG. 1(a) includes a pyroelectric 101, a field effect transistor (FET) 102, and a gate resistor 103. In FIG. 1(b), the horizontal axis is the frequency of a rotational chopper (not shown), the vertical axis is the output voltage, and curves A to C are shown, with the material of the pyroelectric and the gate resistance sewing as parameters.

Patent Literature 3 discloses that lowering the gate resistance reduces, and thus can cut, sensitivity in the lower region, but because the size of an output signal is still dependent on the frequency there is a possibility of false detection or non-detection depending on the speed of motion of the detection target.

### CITATION LIST

### Patent Literature

[PTL 1] JP 2010-258623A

[PTL 2] JP H11-259206A

[PTL 3] JP H5-296830A

### SUMMARY OF INVENTION

### Technical Problem

Accordingly, an object of the present invention is to provide a motion detector capable of reliably detecting the motion of an object that is the target of detection.

### Solution to Problem

The aforementioned object of the present invention is achieved by a motion detector comprising a substrate on a surface of which a plurality of pyroelectric elements for detecting infrared light emitted from an object are placed at intervals, a detection circuit for converting an input signal from each pyroelectric element into a voltage signal to output the voltage signal, and a determination means for comparing the output signal of the detection circuit with a preset reference value to determine whether or not there is a motion of the object in detection regions that are set within predetermined detection distances from the pyroelectric elements, wherein the output signal of the detection circuit is configured to be constant in a set frequency band, and the motion detector further comprises a movement information calculating means for calculating movement information containing information on a distance to the object and a direction of movement of the object determined by the determination means.

Since the motion detector having the foregoing configuration can make the output signal of the detection circuit substantially uniform in a frequency band necessary for detecting an object such as a human body, the motion detector can reliably detect the object that is present in detection regions irrespective of the speed of motion and also can obtain an output signal having a size that corresponds to the distance to the object. Moreover, the motion detector can exclude from the detection target the motion of an object that is present outside detection regions, i.e., that is present at a position further away than a detection distance corresponding to the preset threshold value, and can clearly define the distal ends (outer edges in the direction of detection) of the detection regions. Therefore, detection of motion including information of the distance to the object can be reliably performed. For example, the further the distance from the place where an object passes as indicated by the arrows in FIGS. 2(a) to 2(c) to a pyroelectric element P, the lower the peak of an output signal Os of the detection circuit as shown in the time waveform in FIGS. 2(d) to 2(f), and the size of this output signal Os is not dependent on the speed of the object. Therefore, suitably setting a threshold value Th relative to the output signal Os makes it possible to set a detection region Da having a distal end De at a distance corresponding to this threshold value Th. In the detection region Da, an output signal Os having a size corresponding to the distance from the pyroelectric element P to the object can be obtained, and, therefore, for example, the current location of the object can be recognized. The frequency band in which the output signal of the detection circuit is made constant is not particularly limited, and may be suitably set according to the purpose or the intended use of the motion detector. For example, if the primary purpose is detecting the movement of a hand, the frequency band can be set at 1 to 10 Hz, and when the primary purpose is detecting the movement of a body the frequency band can be set at 0.2 to 1 Hz. This frequency band can be set in advance, and, also, may be configured so as to be suitably changed by a user as necessary. The output signal being “constant” is defined that, when the output signals of the detection circuit at the respective ends of a set frequency band are compared and the larger output signal is regarded as a reference signal, the output signal is maintained so as not to be 3 dB or greater below the reference signal over the entirety of the set frequency band.

Furthermore, since multiple pyroelectric elements P are placed at intervals on the surface of the substrate, the motion detector of the present invention can recognize the direction of movement of an object from the output signals of the detection circuits corresponding to the respective pyroelectric elements P. For example, as shown in FIGS. 3(a) and 3(b), in a configuration in which two pyroelectric elements P1 and P2 are placed on a curved substrate S, the time waveforms of output signals Os1 and Os2 corresponding to the pyroelectric elements P1 and P2, respectively, that are obtained when an object passes through their detection regions D1 and D2 in the directions indicated by the arrows are FIGS. 3(c) and 3(d), respectively. It is therefore possible to recognize the distance to the object from the sizes of the output signals Os1 and Os2, and also possible to determine the direction of movement of the object from the order of generation of the output signals Os1 and Os2. Moreover, the output times of the output signals Os1 and Os2 correspond to the speed of the object passing through the detection regions D1 and D2, respectively, and it is thus possible to calculate the speed of movement of the object from the lengths of the output times.

In the above-described motion detector, the pyroelectric elements can constitute a plurality of sensor groups classified according to the size of the detection distance, and the detection regions of the pyroelectric elements can be placed such that the detection regions of the pyroelectric elements included in the same sensor group overlap while the detection regions of the pyroelectric elements included in different sensor groups do not overlap. According to this configuration, since it is possible to calculate information on the distance and the direction of movement of an object passing through the overlapping region of the detection regions in each sensor group, and the sensor groups are classified according to the detection distance, it is possible to accurately obtain distance information on the object over a large area. Moreover, the distal ends of the detection regions of each sensor group can be clearly defined, and therefore overlapping of the detection regions of different sensor groups can be easily avoided, thus making it possible to prevent false detection.

It is preferable that in the above-described motion detector of the present invention having a plurality of sensor groups, the pyroelectric elements constituting one of the sensor groups are placed at an equal distance from a predetermined detection position that is on an imaginary straight line extending in toward and away from the substrate such that the detection regions overlap at the detection position. According to this configuration, the current position along the imaginary straight line and the direction of movement of an object can be precisely recognized from the detection results of the sensor groups. As a specific example of such a motion detector, configuring a motion detector to comprise a plurality of strip-like objects, on which the pyroelectric elements are linearly placed and which are curved into a rounded shape, such that the strip-like objects radially extend, with the position of intersection with the imaginary straight line being the center, makes manufacturing easy.

Moreover, the above-described motion detector having a plurality of sensor groups can be configured such that at least a pair of the pyroelectric elements included in any of the sensor groups output signals of mutually reverse polarities. According to this configuration, combining the detection results of the pyroelectric element pair that output signals of mutually reverse polarities makes it possible to obtain more accurate information on the distance and information on the direction of movement of an object.

It is possible to configure the motion detector of the present invention to further comprise a light source for outputting modulated light modulated to a predetermined frequency, wherein the movement information calculating means distinguishes the modulated light detected by the pyroelectric elements from infrared light emitted from an object and obtains information contained in the modulated light. According to this configuration, the detection target and the intended use of detection can be expanded by taking advantage of additional information contained in the modulated light.

It is possible to configure the motion detector of the present invention such that the detection region of each pyroelectric element is divided into a plurality of portions, the detection region of any of the pyroelectric elements respectively overlaps, near its distal end, a plurality of preset space regions, and an overlap between the space region and the detection region occurs due to a different pyroelectric element depending on the space region. According to this configuration, not only can information on the distance of an object in each space region be obtained, but also the current position and the direction of movement of the object between a plurality of space regions can be recognized, and information (positional information) on the distance and information on the direction of movement of the object corresponding to each space region can be obtained.

Moreover, it is possible to configure that, by placing three or more pyroelectric elements on the substrate, the overlap between the space region and the detection region occurs due to a different combination of the pyroelectric elements depending on the space region. According to this configuration, even when a large number of narrow, small space regions need to be set, information (positional information) on the distance and information on the direction of movement of the object corresponding to each space region can be easily obtained.

The motion detector of the present invention can be configured to further comprise a chopper that has an opening with substantially the same size as the pyroelectric elements in the cylindrical side wall and is rotatable by a drive means, wherein the substrate is accommodated in the chopper and curved along the inner surface of the side wall. According to this configuration, it is possible to reliably detect not only the motion of a moving object but also the presence of a stationary object.

### Advantageous Effects of Invention

According to the present invention, a motion detector capable of reliably detecting the motion of an object that is the target of detection can be provided.

### BRIEF DESCRIPTION OF DRAWINGS

FIG. 1(a) is a configurational diagram of a circuit of a conventional motion detector, and FIG. 1(b) is a chart showing an example of frequency response characteristics of this motion detector.

FIGS. 2(a) to 2(c) are diagrams each showing an example of an object passing through the detection region of a single pyroelectric element, and FIGS. 2(d) to 2(e) are diagrams each showing an example of the output signal of the single pyroelectric element corresponding to the passing position of the object.

FIGS. 3(a) and 3(b) are diagrams each showing an example of an object passing through detection regions of a plurality of pyroelectric elements, and FIGS. 3(c) and 2(d) are diagrams each showing an example of the output signals of the pyroelectric elements corresponding to the passing position of the object.

FIG. 4 is a plan view of a motion detector according to one embodiment of the present invention.

FIG. 5 is a cross-sectional view taken along the line A-A in FIG. 4.

FIG. 6 is an enlarged view of relevant parts in the cross-section taken along the line B-B in FIG. 4.

FIG. 7 is a configurational diagram of a circuit, showing an example of a detection circuit included in the motion detector shown in FIG. 1.

FIG. 8 is a chart showing an example of the frequency response characteristics of the detection circuit shown in FIG. 7.

FIGS. 9(a) to 9(c) are diagrams each showing an example of an object passing through the detection region of a pyroelectric element in the motion detector shown in FIG. 4, and FIGS. 9(d) to 9(e) are diagrams each showing an example of the output signal of the pyroelectric element corresponding to the passing position of the object.

FIG. 10 is a schematic cross-sectional view of relevant parts of the configuration shown in FIG. 5.

FIG. 11 is a schematic perspective view of a motion detector according to another embodiment of the present invention.

FIG. 12 is a configurational diagram of a circuit, showing another example of a detection circuit included in the motion detector shown in FIG. 4.

FIG. 13 is a chart showing an example of the frequency response characteristics of the detection circuit shown in FIG. 12.

FIG. 14 is a cross-sectional view of a motion detector according to another embodiment of the present invention.

FIG. 15 is a cross-sectional view of a motion detector according to yet another embodiment of the present invention.

FIG. 16 is a cross-sectional view of a motion detector according to yet another embodiment of the present invention.

FIG. 17 is a plan view of the configuration shown in FIG. 16.

FIGS. 18(a) to 18(c) are diagrams each showing an example of an object passing through the detection regions of a plurality of pyroelectric elements in a modification of the motion detector of the present invention, and FIGS. 18(d) to 18(f) are diagrams each showing the result obtained by combining the output signals of the plurality of pyroelectric elements corresponding to the passing positions of the object.

FIG. 19 is a schematic perspective view of a motion detector according to another embodiment of the present invention.

FIGS. 20(a) and 20(b) are diagrams each showing an example of the time waveform of an output signal obtained from the motion detector of the present invention combined with a light source for outputting modulated light. They are schematic side views for explaining the detection region of a light receiving element.

FIG. 21 is a schematic side view for explaining an example of the detection region of a pyroelectric element.

FIG. 22 is a schematic side view for explaining detection regions of a motion detector according to yet another embodiment of the present invention.

FIG. 23 is a schematic side view for explaining detection regions of the motion detector shown in FIG. 22 in another curved state.

FIG. 24 is a side view of a motion detector according to yet another embodiment of the present invention.

FIG. 25 is a cross-sectional view taken along the line C-C in FIG. 24.

FIG. 26 is a schematic side view for explaining detection regions of the motion detector shown in FIG. 22 in yet another curved state.

FIG. 27 is a schematic configurational diagram of a signal processor and a control device.

FIG. 28(a) is a diagram showing an example of an object passing through detection regions of a plurality of pyroelectric elements, and FIG. 28(b) is a diagram showing an example of the respective output signals of the plurality of pyroelectric elements due to the passage of the object.

### DESCRIPTION OF EMBODIMENTS

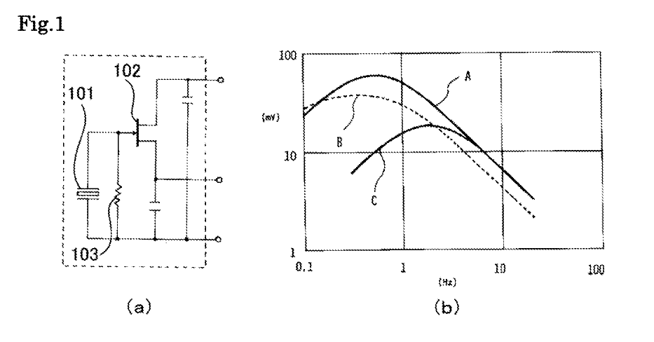

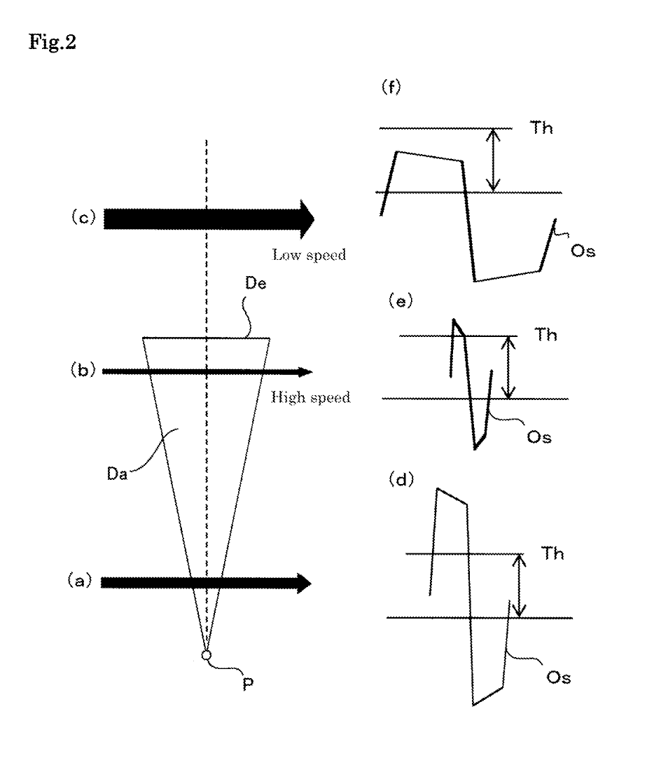

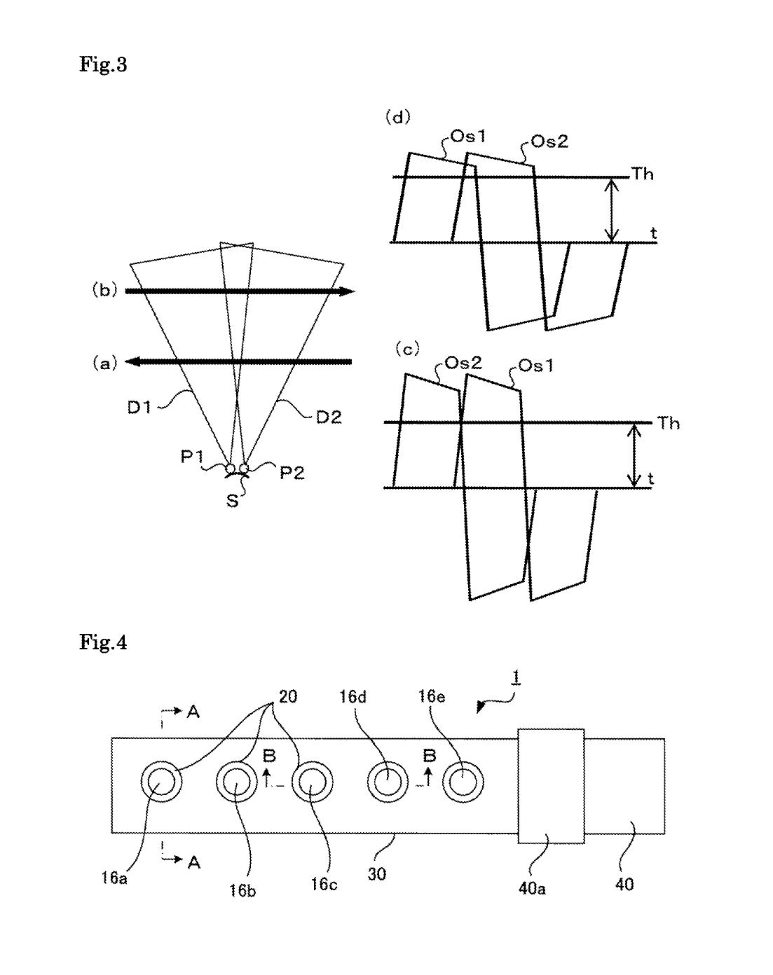

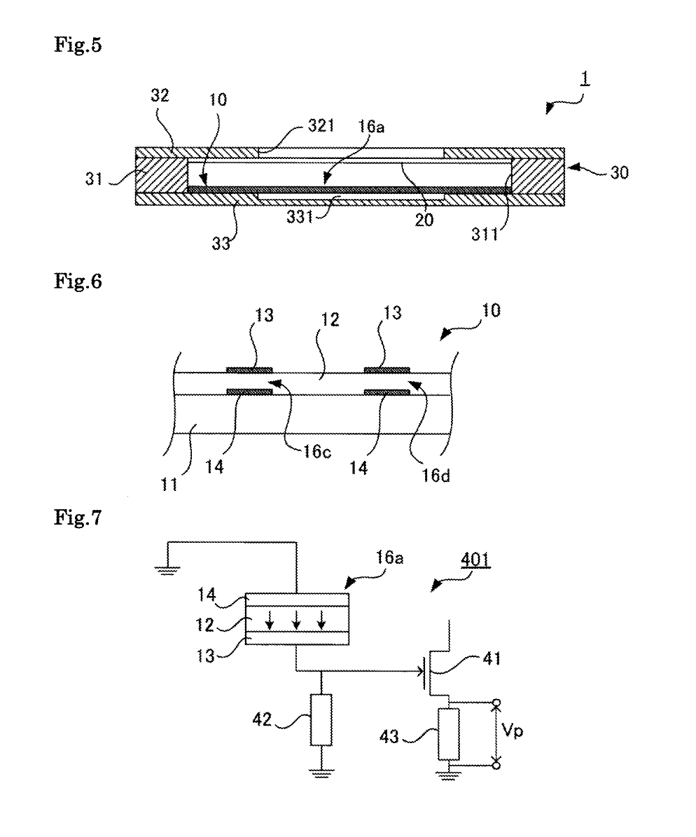

Below, an embodiment of the present invention will now be described with reference to the attached drawings. FIG. 4 is a plan view of a motion detector according to one embodiment of the present invention, and FIG. 5 is a cross-sectional view taken along the line A-A in FIG. 1. As shown in FIGS. 4 and 5, a motion detector 1 comprises a substrate 10, a casing 30 accommodating the substrate 10, a signal processor 40, and a control device 90.

FIG. 6 is an enlarged view of relevant parts showing the configuration of the substrate 10 in the cross-section taken along the line B-B in FIG. 4. As shown in FIG. 6, the substrate 10 has a pyroelectric film 12 that is formed on the surface of a supporting base material 11, and light receiving electrodes 13 and counter electrodes 14 are placed on the front and back surfaces of the pyroelectric film 12, respectively. The supporting base material 11 is a sheet-like member that is composed of a polymeric material such as polyimide, polyamide, polyethylene terephthalate (PET), or polyethylene naphthalate (PEN) and has a thickness of about 5 to 200 μm.

For the pyroelectric film 12, a film with a heat capacity and a dielectric constant sufficiently reduced for an increased detection sensitivity can be used. For a reduced heat capacity, it is preferable to set the film thickness in the range of, for example, 100 to 1500 nm, and it is preferable to uniformly form the film by a spin coat method or vacuum deposition. The film thickness can be measured, for example, by a surface profiler or spectroscopy. It is also effective to reduce the dielectric constant, and materials having a relative dielectric constant of about 5 to 10 are preferably usable. The relative dielectric constant can be measured using an impedance analyzer, and, for example, a Solatron impedance/gain phase analyzer 1260 and a dielectric interface 1296 of TOYO Corporation are usable.

As a specific material of the pyroelectric film 12, any of organic materials and inorganic materials may be used, and an organic ferroelectric that can be easily formed into a thin film is preferable. A material that exhibits a pyroelectric effect is required to be a dielectric having a spontaneous polarization and having a polar portion due to the molecular structure or intermolecular interaction. Examples include a series of compounds such as polyvinylidene fluoride (PVDF) having CH2-CF2 in which hydrogen (H) and fluorine (F) are placed on the carbon (C) chain as a fundamental unit of the polar portion and copolymers thereof, vinylidene cyanide compounds in which CN composed of C and nitrogen (N) is the polar portion; urethane compounds such as polyurea in which the urea bond portion (NH—C═O—NH) is the polar portion; Nylons that are polyamide compounds in which a hydrogen bond serves as the polar portion (in particular, Nylon 7 and Nylon 11 having 7 and 11 carbon atoms, respectively); and some polyester materials such as the L isomer of polylactic acid having an OH group. Moreover, in order to enhance the pyroelectric effect, a complex system of an organic material and an inorganic polar material such as lead zimonate titanate (PZT) or barium titanate is also usable.

For the light receiving electrodes 13 and the counter electrodes 14, for example, films on which metals such as Au, Ag, Al, Cr, Ni and Pt or alloys of these metals are deposited, carbon deposited films, organic electrodes of for example, polyaniline, polythiophene, and PEDOT-PSS, and like electrodes are usable. The light receiving electrodes 13 are preferably composed of a material having high infrared permeability or infrared absorbability.

The substrate 10 having the above-described configuration can be obtained by, for example, forming the counter electrodes 14 on the surface of the supporting base material 11 by vacuum deposition, spin coating, or the like, then forming the pyroelectric film 12 on the surface of the counter electrodes 14 by vacuum deposition or the like, and forming the light receiving electrodes 13 on the surface of the pyroelectric film 12 by vacuum deposition, spin coating, or the like. When the pyroelectric film 12 has a sufficient thickness and thus can support itself, the substrate 10 can be configured without using the supporting base material 11.

A plurality of light receiving electrodes 13 and counter electrodes 14 are provided in a divided manner in the longitudinal direction of the supporting base material 11, and are placed so as to face one another, with the pyroelectric film 12 therebetween. Due to the polarization treatment performed between the light receiving electrodes 13 and the counter electrodes 14 facing one another, the pyroelectric film 12 forms a plurality of pyroelectric elements 16a to 16e that are placed in-line (FIG. 6 shows two pyroelectric elements 16c and 16d). It is also possible that either the light receiving electrodes 13 or the counter electrodes 14 are formed in a divided manner, and the other electrodes are formed as a single common electrode. The pyroelectric elements 16a to 16e can be formed by performing patterning on the pyroelectric film 12 using a mask or photolithography.

As shown in FIG. 5, the front surface and the back surface of a frame 31 are covered with a cap 32 and a base 33, respectively, and the casing 30 is thus formed into a flat enclosure having a rectangular shape as viewed from above. The frame 31 constituting the side wall of the casing 30 is formed such that through-holes 311 are provided at equal intervals in the longitudinal direction of a long and thin plate-shaped member in the direction penetrating FIG. 5), and accommodates the pyroelectric elements 16a to 16e of the substrate 10 placed on the base 33 in the respective through-holes 311.

The cap 32 has a slit 321 immediately above each of the pyroelectric elements 16a to 16e. The inner surface side of the cap 32 is covered by a window material 20 composed of, for example, silicon or high-density polyethylene. Immediately below each of the pyroelectric elements 16a to 16e, the base 33 has a depression 331 formed so as to have substantially the same size as the pyroelectric elements 16a to 16e for achieving a low heat capacity. The through-holes 311 of the frame 31 are tightly closed by the window material 20, the cap 32, and the base 33. This tightly closed space may be filled with inert gas such as nitrogen or evacuated to a vacuum to enhance the detection sensitivity of the pyroelectric elements 16a to 16e.

The casing 30 can be formed from a material such as rubber, synthetic resin, or metal. In order to shield the inside of the through-holes 311 from external disturbances, it is preferable to form the casing 30 from a conductive material, or form a conductive coating layer on the inner surface side.

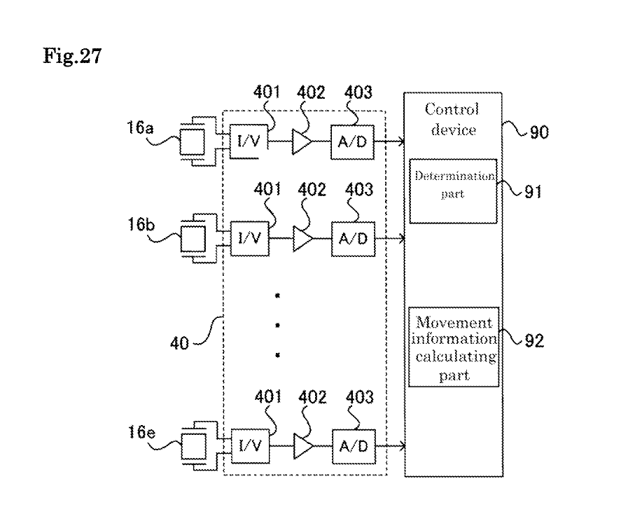

As shown in FIG. 4, the signal processor 40 is removably attached to the casing 30 via a connector 40a. As shown in FIG. 27, the signal processor 40 comprises a detection circuit 401 for converting an input signal from the pyroelectric elements 16a to 16e into a voltage signal to output a detection signal, an operational amplifier 402 for amplifying and filtering the detection signal, and an A/D converter 403 for performing analog-digital conversion of the detection signal that has passed through the operational amplifier 402. A plurality of detection circuits 401, operational amplifiers 402, and A/D converters 403 are provided so as to correspond to the respective pyroelectric elements 16a to 16e. The control device 90 is linked to the signal processor 40 by a wired or wireless connection, and comprises a determination means 91 for comparing a digital signal inputted from the signal processor 40 with a preset reference value to determine whether or not there is a motion of an object in detection regions and a movement information calculating means 92 for calculating movement information of the object determined by the determination means 91. The signal processor 40 does not necessarily need to be provided separately from the pyroelectric elements 16a to 16e as in this embodiment, and may be configured to be integrated into a single body by individually placing a signal processor near each of the pyroelectric elements 16a to 16e. Alternatively, the signal processor 40 can be configured to be incorporated in the control device 90.

FIG. 7 is a circuit configurational diagram of the detection circuit 401 of this embodiment. The detection circuit shown in FIG. 7 is an example of a circuit referred to as a so-called voltage readout type or voltage follower type, and is configured to include an FET 41, a reference resistor 42, and a source resistor 43 per one pyroelectric element 16a (this also applies to other pyroelectric elements 16b to 16e). The pyroelectric element 16a and the reference resistor 42 are parallely connected to the gate of the FET 41, and the source resistor 43 is provided between the source and the ground of the FET 41, thus making it possible to extract an output signal Vp that is a detection signal. When a current signal is outputted from the pyroelectric element 16a that has detected heat emitted from an object such as a human body, this current signal is inputted as a voltage signal into the gate of the FET 41 by the reference resistor 42. Accordingly, the source voltage of the FET 41 changes, and the output signal Vp that is a voltage signal is obtained. In this embodiment, the FET 41 is a junction FET (JFET).

The detection signal generated by the detection circuit 401 is filtered, amplified, and analog-digital-converted by the operational amplifier 402 and the A/D converter 403, and then sent to the control device 90 that is linked by a wired or wireless connection. The control device 90 compares the detection signal with the reference value (threshold value) in the determination means 91 and determines whether or not an object such as a human body has moved in the detection regions of the pyroelectric elements 16a to 16e. For the object determined as being present, the movement information calculating means 92 calculates movement information containing information on the distance to the object and the direction of movement of the object based on the size of the detection signal and the movement between detection regions. Based on the movement information obtained in this way, an operation of, for example, various electronic apparatuses can be performed. For example, if this motion detector 1 is provided in a portable electronic apparatus, the position of input by a finger, the direction of movement, and the like can be determined, thus enabling preset device operations to be performed.

In the detection circuit shown in FIG. 7, normally the resistance value of the reference resistor 42 is set at a large value on the order of giga Ω to increase detection sensitivity. However, if a conventional high-resistance reference resistor 42 is used, as will be described below, a cutoff by τ_{E} occurs in the 0.5 to 10 Hz frequency band that is necessary for detecting a movement of in particular a human body, and the output signal Vp depends greatly on the frequency, and thus there is a possibility that an accurate detection cannot be performed depending on the speed of movement.

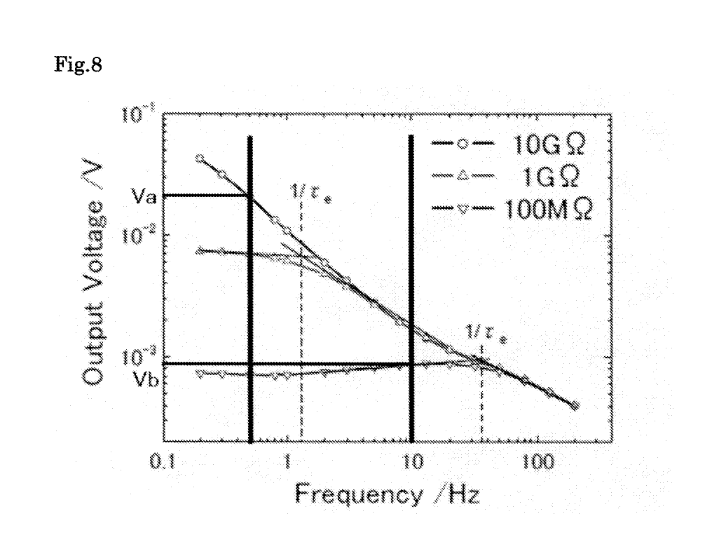

FIG. 8 is a chart showing the relationship between the output voltage of the signal processor 40 and the frequency, with the resistance value of the reference resistor 42 being a parameter, in the motion detector 1 including a detection circuit of a voltage readout type. The frequency on the horizontal axis, as with conventional methods of examining the frequency response characteristics of a pyroelectric sensor, corresponds to the rotational speed of a chopper that intermittently blocks infrared light from a light source, and, during actual detection, corresponds to the speed of movement of an object that is a detection target. As shown in FIG. 8, in the case of the resistance value of the reference resistor 42 being 10 GΩ, if the frequency band is set at 0.5 to 10 Hz, the reference signal is Va that is the larger of the output signals at both ends of the frequency band, i.e., 0.5 Hz and 10 Hz. Compared with this reference signal Va, the output signal at 0.5 to 10 Hz decreases 3 dB or greater as the frequency increases in the 0.5 to 10 Hz range, and is thus not constant. As in the case of 10 GΩ, in the case where the resistance value of the reference resistor 42 is 1 GΩ as well, the output signal of the detection circuit is not constant in the 0.5 to 10 Hz frequency band.

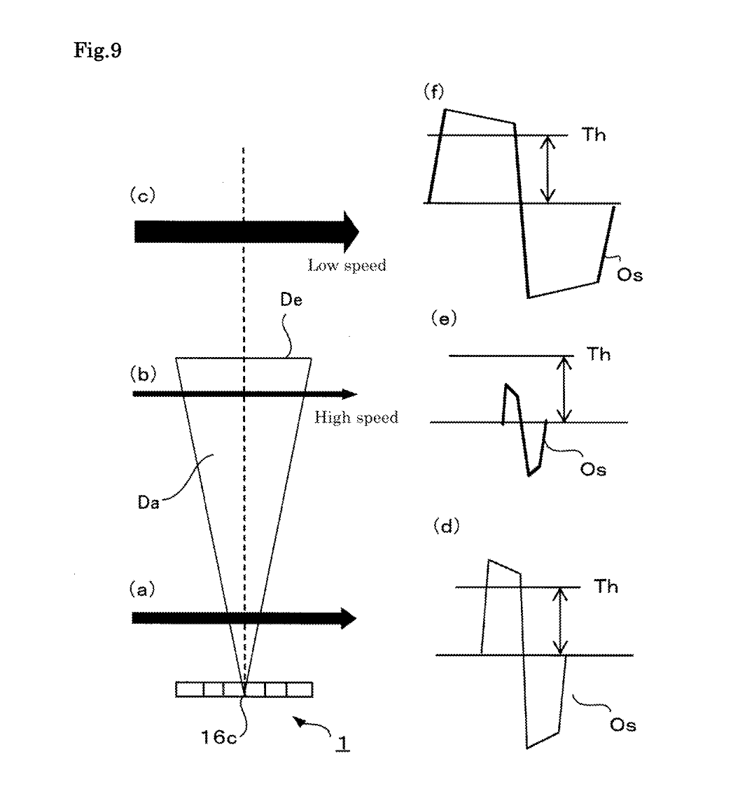

Thus, if the value of the output signal is greatly decreased when the frequency is high in the set frequency band, although an output signal Os exceeds a reference value Th and thus becomes detectable as shown in FIG. 9(d) when an object moves near a pyroelectric element (for example, the pyroelectric element 16c) as shown in FIG. 9(a), there is a possibility that the output signal Os does not exceed the reference value Th and is thus undetectable as shown in FIG. 9(e) when an object moves at high speed near a distal end de within a detection region Da as shown in FIG. 9(b). On the other hand, if the reference value Th is set at a small value to prevent such non-detection, the output signal Os exceeds the reference value Th as shown in FIG. 9(f) and is thus detected, and there is an increased possibility of a false detection when an object (external disturbance) moves at low speed in a place further than the distal end de of the detection region Da as shown in FIG. 9(c).

In general, the output signal (output sensitivity) Vp in a voltage readout type can be represented by mathematical expression 1 below:

$$Vp = \frac{ω SpR η}{G \sqrt{1 + {ω}^{2} {τ}_{E}^{2}} \sqrt{1 + {ω}^{2} {τ}_{T}^{2}}} \qquad [ Expression 1 ]$$

Here, ω, S, p, R, and η represent an angular frequency, light receiving area, pyroelectric coefficient, resistance, and absorptivity, respectively Also, τ_{E} and τ_{T} are an electrical time constant and a thermal time constant, respectively. Here, the region between 1/τ_{E} and 1/τ_{T} takes a constant value without being dependent on the angular frequency but is cut off by 1/τ_{E} and 1/τ_{T}. In particular, since τ_{E} is expressed as a product of resistance R and capacity C of a component circuit, the cut-off frequency changes when the value of the reference resistor is changed. Since reducing the value of the reference resistor in the voltage follower circuit results in a reduced resistance R of the component circuit, the cut-off frequency shifts toward the high frequency side.

Accordingly, in this embodiment, setting the value of the reference resistor 42 at 100 MΩ that is sufficiently smaller than values conventionally selected allows the cut-off frequency to shift more toward the high frequency side than 10 Hz is as shown in FIG. 8, and thus a constant output signal is achieved in the 0.5 to 10 Hz frequency band. That is, relative to the reference signal Vb, which is the larger of the output signals at both ends of the frequency band, i.e., 0.5 Hz and 10 Hz, a decrease of 3 dB or greater does not occur to the output signal in the 0.5 to 10 Hz range. Due to this configuration, the distal end of the detection region is made clear, and information on the distance to an object present in the detection region (i.e., the positional information of an object in a detection region) can be obtained precisely. On the other hand, an object present beyond the distal end of the detection region can be excluded as a detection target. The distal end of the detection region is the end part of the detection region in the direction of detection, and is the outer edge of the detection region indicated as a part of a spherical shape. The distance (detection distance) from the motion detector to the distal end of the detection region corresponds to the preset threshold value, and can be suitably set so as to be a desired value. In this embodiment, the frequency band is set at 0.5 to 10 Hz, but it is also possible to set it at another numerical range according to the purpose and the intended use, and the frequency band to be set is not particularly limited. For example, in the case of detecting the movement of a hand, the frequency band can be set at 1 to 10 Hz, and in the case of detecting the movement of a human body, the frequency band may be set at 0.2 to 1 Hz. Moreover, it is also possible to set a different frequency band for each of the pyroelectric elements 16a to 16e.

The reference resistor 42 shows a reduced detection sensitivity when its resistance is lowered, and therefore the motion detector 1 of this embodiment is suitable particularly for short-distance detection. Specifically, it is preferable to set the distance from the pyroelectric elements 16a to 16e to the distal ends of the detection regions (i.e., the detection distances of the pyroelectric elements 16a to 16e) at 30 cm or shorter.

The value of the reference resistor 42 is not limited to the value used in this embodiment, and may be configured to have a low resistance such that the output signal in the 0.5 to 10 Hz frequency band is constant, and may be suitably set in consideration of for example, the quantity of heat of a detection target object and the detection distance. For example, in the case of using the motion detector 1 of this embodiment as a device for operating a portable electronic apparatus by bringing a finger into close contact with the apparatus, the detection sensitivity can be reduced by setting the detection distance at 1 cm or shorter, and it is thus possible to easily achieve constant frequency response characteristics.

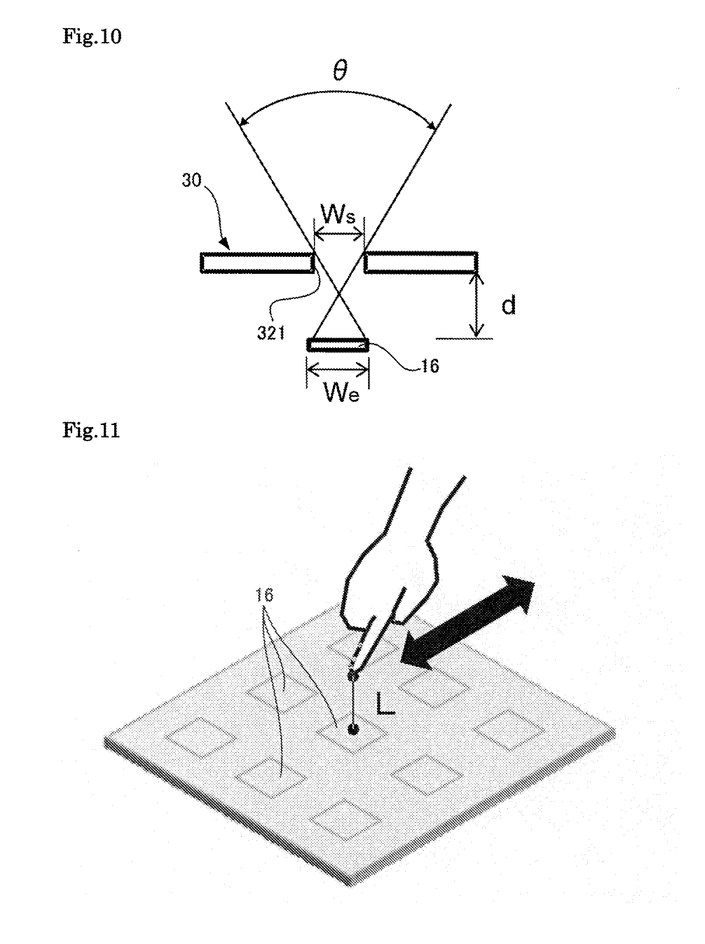

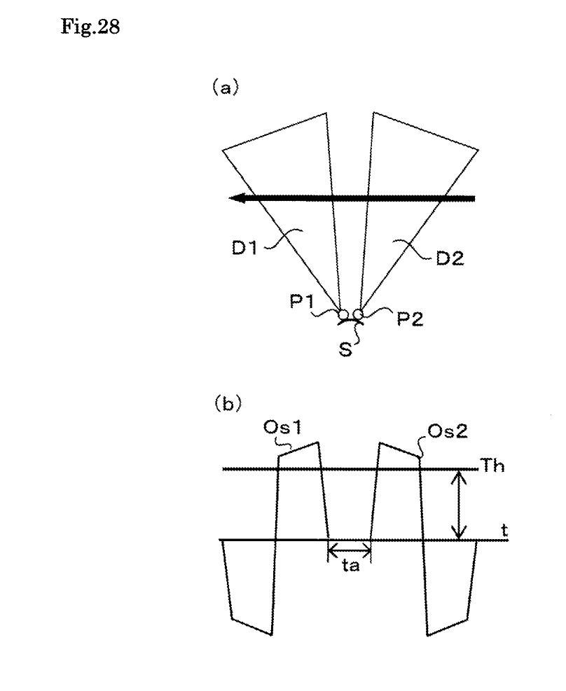

The opening size of the slit 321 of the casing 30 may be set based the detection distances of the pyroelectric elements 16a to 16e such that the detection regions do not interfere with each other. For example, as shown in FIG. 10, a viewing angle θ of the detection region of the pyroelectric element 16 can be expressed as 2 tan⁻¹[(We/2+Ws/2)/d] where the light receiving width of the pyroelectric element 16 (any of the pyroelectric elements 16a to 16e) is We, the width of the opening of the slit 321 is Ws, and the distance from the pyroelectric element 16 to the slit 321 is d. The pitch between the pyroelectric elements 16 and the distance d can be set such that the detection regions do not overlap each other. In this way, the detection regions of the pyroelectric elements 16 can be separated from each other, and thus the direction of movement of an object can be determined from the output signal of each pyroelectric element 16. That is, as shown in FIG. 28(a), in a configuration in which two pyroelectric elements P1 and P2 are placed on a curved substrate S, placing their respective detection regions D1 and D2 so as not to overlap each other results in that the time waveforms of output signals Os1 and Os2 (reverse polarities) corresponding to the pyroelectric elements P1 and P2, respectively, that are obtained when an object passes in the direction indicated by the arrow are FIG. 28(b). Therefore, the distance to the object and the direction of movement can be calculated from the sizes and the order of generation of the output signals Os1 and Os2, and also the speed of movement of the object in each section can be calculated from the lengths of the output times of the output signals Os1 and Os2 and a time interval to between the output signals Os1 and Os2. The detection regions of the pyroelectric elements 16 do not necessarily need to be separated completely, and even in a configuration in which the detection regions partially overlap, it is possible to recognize the current position of and the direction of movement of the object.

In the motion detector 1 of this embodiment, the pyroelectric elements 16a to 16e are placed in one direction, but as shown in FIG. 11, it is possible to configure the motion detector in such a manner that the pyroelectric elements 16 are placed in a matrix form such that the respective detection regions do not overlap, a signal processing circuit is provided near each pyroelectric element 16, and when a distance L from an object such as a finger to a pyroelectric element 16 is within a predetermined detection distance, this pyroelectric element 16 detects the movement of the object. Thus, planarly placing the pyroelectric elements 16 enables detection of movement of an object toward the front, back, right, and left, thus making it possible to expand the operational variation. Moreover, it is also possible to place the pyroelectric elements at suitable intervals along a three-dimensional curved surface such as a depression/projection or a spherical surface.

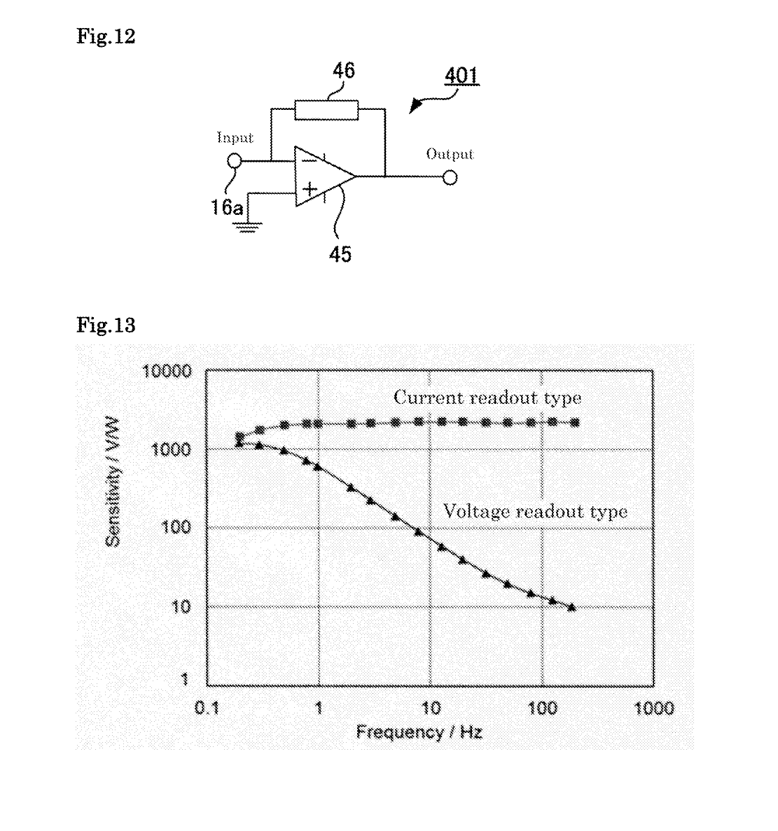

The description provided above is about the case where the signal processor 40 includes a detection circuit of a voltage readout type, but it is also possible to configure this detection circuit to be of a so-called current readout type (also referred to as a transimpedance type). FIG. 12 shows an example of the detection circuit 401 of a current readout type, which is configured to include an operational amplifier 45 and a feedback resister 46 per one pyroelectric element 16a (this is also applicable to other pyroelectric elements 16b to 16e).

FIG. 13 is a chart showing the relationship between the output voltage and the frequency for both the voltage readout type and the current readout type. The resistance values of the reference resistor of the voltage readout type and of the feedback resister of the current readout type are both set at 10 GΩ. As shown in FIG. 13, in the 0.5 to 10 Hz frequency band, the sensitivity decreases as the frequency increases in the case of the voltage readout type, whereas the sensitivity is not frequency-dependent and is constant in the case of the current readout type.

In general, an output signal (output sensitivity) Vi in the current readout type can be represented by mathematical expression 2 below.

$$Vi = \frac{ωη Sp}{G \sqrt{1 + {ω}^{2} {τ}_{T}^{2}}} {R}_{f} \qquad [ Expression 2 ]$$

Here, Rf is the feedback resistance of the operational amplifier. When 1/τ_{T}<<ω, τ_{T}=H/G (where H is a heat capacity), and therefore the output signal (output sensitivity) Vi is a constant approximated by mathematical expression 3 below and is not dependent on the angular frequency ω.

$$Vi = \frac{η {SpR}_{f}}{H} \qquad [ Expression 3 ]$$

That is, in the current readout type, the output signal is, design-wise, not dependent on the frequency and the cut-off frequency does not exist unless there is a feedback capacity. Moreover, as is clear from mathematical expression 3 above, the larger the feedback resistance Rf is and the smaller the heat capacity H is, the greater the Vi can be, and it is therefore preferable to set as large a feedback resistance Rf as possible to such an extent that a noise problem does not occur.

Thus, when the detection circuit of the signal processor 40 is a current readout type, sufficiently reducing the heat capacities of the pyroelectric elements 16a to 16e makes it possible to easily achieve a constant and highly sensitive output signal in the set frequency band. Therefore, a larger detection distance can be attained than by the voltage readout type, and the current readout type can be suitably used in detection applications in which the detection distance is intermediate (for example, about 30 cm to 3 m).

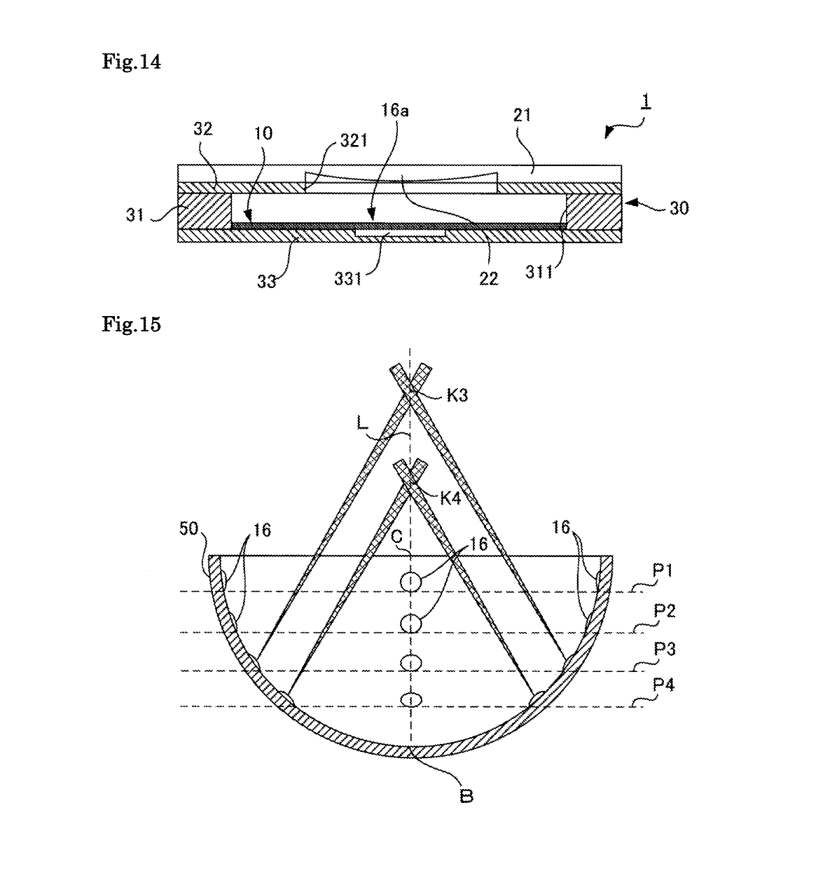

In this case, adjusting the field of view of each of the pyroelectric elements 16a to 16e by the opening size of the slit 321 of the casing 30 as in the case of the voltage readout type results in an excessively expanded field of view near the distal end of the detection region, and there is a possibility that a detection target object cannot be detected accurately. Thus, as shown in a cross-sectional view in FIG. 14, it is preferable that a narrow-field lens 22 is formed by, for example, injection molding using a metal mold on one surface of a substrate film 21 having infrared permeability such as polyethylene, and the substrate film 21 is placed on the surface of the cap 32 of the casing 30 such that this narrow-field lens 22 is positioned immediately above each of the pyroelectric elements 16a to 16e via the slit 321. In FIG. 14, the same components as in FIG. 5 are given the same reference numbers.

The narrow-field lens 22 is, for example, an Fresnel lens and is set to have a narrow viewing angle (for example, about 2 to 5°) such that the detection region of each of the pyroelectric elements 16a to 16e is narrow. Accordingly, the detection region does not become very broadened even in the vicinity of the distal end, and therefore even when a detection target object is at the distal end of the detection region, the entirety of this distal end can fit within the detection target, thus enabling accurate detection of movement.

For example, when the motion detector 1 is used for operating software by the movement of a hand during a presentation, the viewing angle of the narrow-field lens 22 may be set such that, if the detecting target is the palm, the distal end of the detection region is smaller than the palm. Specifically, if the detection distance is 1 m, setting the viewing angle at 2.5° results in that the size of the distal end of the detection region is about φ80, and it is thus possible to make the distal end sufficiently smaller than the size of the palm. Accordingly, there is no possibility of detecting also a heat source such as an arm other than the palm, and a false detection associated with a change of heat-source size can be reliably prevented.

For the motion detector 1 shown in FIG. 14 as well, it is preferable to provide a plurality of pyroelectric elements. When placing a plurality of pyroelectric elements, the pyroelectric elements can be placed on a two-dimensional flat surface or a three-dimensional curved surface, and detection regions can be set so as not to overlap each other by adjusting the viewing angles of the narrow-field lenses 22. However, in this configuration as well, detection regions of a plurality of pyroelectric elements may partially overlap.

As an example of the case where pyroelectric elements are placed on a three-dimensional curved surface, a plurality of pyroelectric elements 16 can be placed on the inner circumferential surface of a hemispherical support 50 as shown in the cross-sectional view of FIG. 15. In this case, an imaginary straight line L that connects a hemisphere center C and a bottom B of the support 50 is set, and a plurality of pyroelectric elements 16 located on an imaginary plane (for example, P1) perpendicular to this virtual straight line L constitute one sensor group. Setting a plurality of imaginary planes (P1 to P4) makes it possible to form a plurality of sensor groups. The fields of view of the pyroelectric elements 16 included in the same sensor group are set such that the detection regions overlap each other in a predetermined detection position on the imaginary straight line L, and the pyroelectric elements 16 are adjusted such that different sensor groups have different detection positions. For example, the sensor group defined by an imaginary plane P3 has a detection position K3 while the sensor group defined by an imaginary plane P4 has a detection position K4. Each pyroelectric element 16 can be formed from the pyroelectric film 12 as with the above-described pyroelectric elements 16a to 16e, and the shape of the pyroelectric film 12 is not particularly limited, including, for example, a shape formed by bending a planar film or a shape formed by concentrically combining ring-like films.

According to the motion detector 1 shown in FIG. 15, when an object such as a finger or a hand moves along the imaginary straight line L extending in the directions toward and away from the support 50 and the object reaches a detection position, all pyroelectric elements 16 of a sensor group corresponding to the detection position detect the object, and thus the presence of the object can be recognized. Therefore, placing such sensor groups so as to have mutually different detection positions makes it possible to recognize the current position and the direction of movement of the object from the detection result of each sensor group.

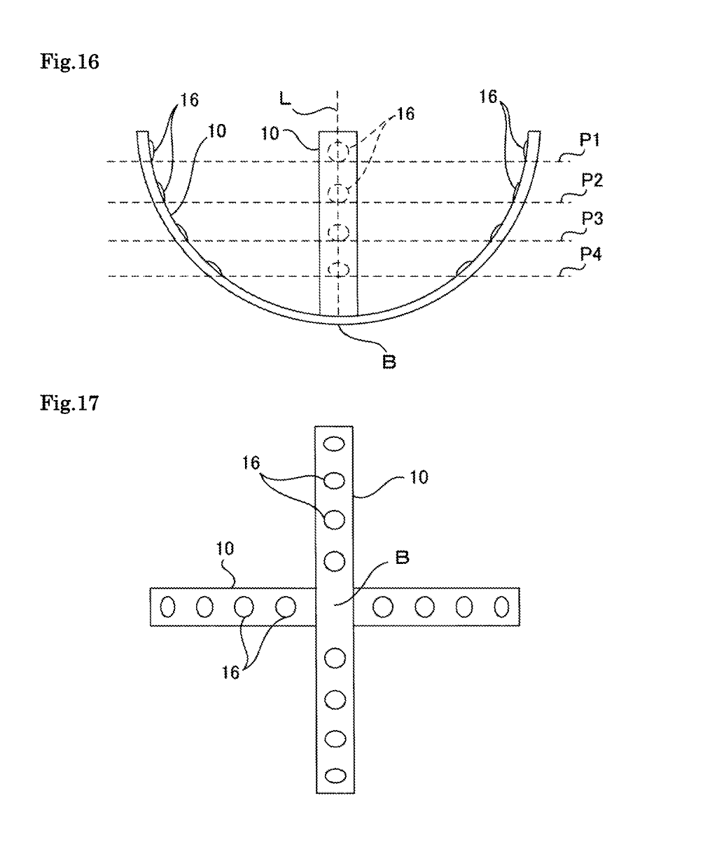

The same arrangement of the pyroelectric elements 16 as that shown in FIG. 15 can be achieved also by providing a plurality of substrates that are each obtained by bending into a rounded shape the substrate 10 shown in, for example, FIG. 4 on which the pyroelectric elements 16a to 16e are linearly arranged and radially combining the substrates as shown in the side view and the plan view of FIGS. 16 and 17, respectively, thus making it possible to simplify the manufacturing process. In this case, the substrates 10 correspond to the support 50 shown in FIG. 15, and the imaginary straight line L can be set so as to intersect the radial center (bottom B) of the substrates 10. The supporting base material 11 of the substrates 10 is preferably a flexible board (FPC) of, for example, polyimide or PEN as in the configuration of FIG. 4 or the like. The configuration comprising a plurality of sensor groups is not limited to the configuration in which detection regions overlap on the imaginary straight line L extending in the directions toward and away from the substrate B as shown in FIG. 15 or 16, and other configurations may be used as long as the detection regions of pyroelectric elements included in the same sensor group are placed so as to overlap each other. Sensor groups can be classified according to the size of detection distance, thus an overlap of detection regions between different sensor groups can be easily prevented, and distance information of an object over a large area can be obtained.

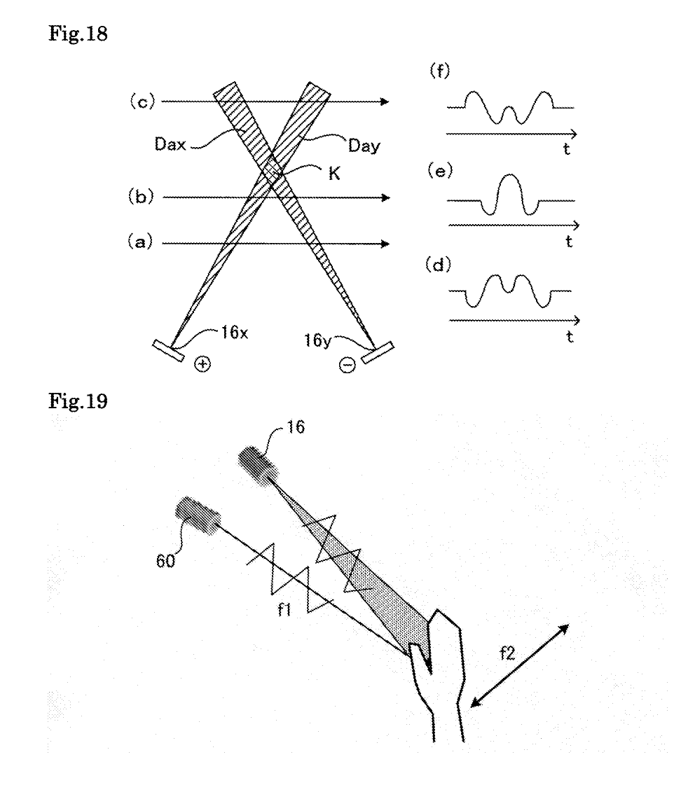

In the above-described configuration comprising a plurality of sensor groups, at least a pair of pyroelectric elements 16 among those constituting one sensor group are serially connected in reverse polarities (that is, light receiving electrodes are connected to each other or counter electrodes are connected to each other) to form a dual element by these pyroelectric elements 16 and 16, and it is thus possible to obtain information on the distance to an object even when the object moves in a direction different from the imaginary straight line L. For example, as shown in FIG. 18(a), when an object passes through a place near a pair of pyroelectric elements 16x and 16y that constitute a dual element and output signals of mutually reverse polarities, the time waveform obtained by synthesizing output signals of the pyroelectric elements 16x and 16y is, as shown in FIG. 18(d), one in which the waveforms generated when the object passes through detection regions Dax and Day of the pyroelectric elements 16x and 16y each appear independently. When the place where the object passes is farther, as shown in FIG. 18(b), the wave forms generated due to passing through detection regions Da and Da partially overlap as shown in FIG. 18(e). Then, when the place where the object passes is even farther and exceeds an overlapping region K of the detection regions as shown in FIG. 18(c), the waveforms generated due to passing through the detection regions Dax and Day appear in an inverted shape as shown in FIG. 18(f). Thus, the time waveform of output signals changes according to the place where an object passes, and therefore associating various time waveforms with distances to an object in advance makes it possible to obtain information on the distance to the object that moves in various directions. A pair of pyroelectric elements 16x and 16y having different polarities do not necessarily need to be connected in series, and may be connected in any manner as long as their waveforms can be compared chronologically.

The motion detectors of the above embodiments can also be used in combination with a light source for outputting modulated light modulated to a predetermined frequency. That is, as shown in FIG. 19, a light source 60 such as an LED for outputting modulated light is provided near a pyroelectric element 16, and the pyroelectric element 16 is configured to detect reflected light of the modulated light reflected on the surface of an object, for example, when the object reaches near the detection region of the pyroelectric element 16. It is preferable that a modulation frequency f1 of the light source 60 is set to be markedly greater than a frequency f2 that corresponds to the speed of movement of the object such that even when the infrared light emitted from the object is superimposed on the modulated light and detected by the pyroelectric element 16, the infrared light and the modulated light are easily distinguished to make it possible to obtain infrared light information and modulated light information. For example, it is preferable to set the modulation frequency f1 at 200 Hz or higher.

According to the configuration shown in FIG. 19, in addition to the detection of the movement of an object using infrared light, additional information can be obtained by the detection of modulated light. For example, even when an object the pyroelectric element 16 cannot detect such as an object that does not emit heat rays passes through the detection region, such an object can be detected by detecting modulated light. Furthermore, the application of, for example, a triangulation method or a TOF (Time of Flight) method to modulated light makes it possible to obtain positional information of a moving object and a stationary object, or inclusion of authentication information in modulated light enables application to a security system.

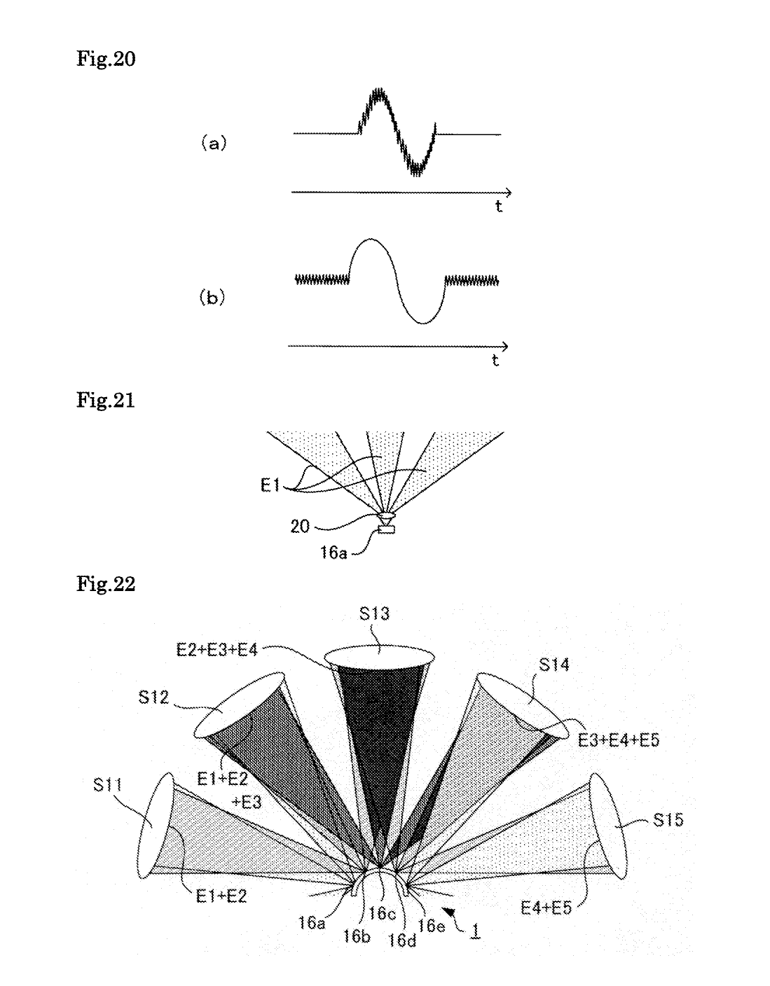

The way modulated light is detected by the pyroelectric element 16 is not limited to the reflection type described above, and a transmission-type configuration can be adopted in which the light source 60 is placed such that the pyroelectric element 16 detects direct light of modulated light, and the modulated light is blocked when an object passes. In the case of the reflection type in which reflected light of modulated light is detected, the detection of modulated light is mainly carried out simultaneously with the detection of infrared light from an object, and therefore the time waveform of an output signal has a shape in which the modulated light of a light source is superimposed on the infrared light from an object as shown in FIG. 20(a). On the other hand, in the transmission type in which direct light of modulated light is detected, modulated light is constantly detected, and modulated light is blocked mainly when the motion of an object is detected, and therefore the time waveform of an output signal has a shape in which the infrared light of an object and the modulated light of a light source are combined at different timings as shown in FIG. 20(b). Therefore, in any of the configurations, it is possible to distinguish modulated light from the light source 60 from infrared light from an object and extract the modulated light.

The motion detector of the present invention can also be configured such that the substrate 10 on which the pyroelectric elements 16a to 16e are linearly placed are bent into a shape rounded in the direction opposite to the direction in the configuration shown in FIGS. 16 and 17. In this configuration, dividing a detection region E1 of the pyroelectric element 16a (the same also applies to detection regions E2 to E5 of other pyroelectric elements 16b to 16e) into a plurality of portions using a condensing lens 20 or the like such that a no-detection region is interposed between the divided portions as shown in FIG. 21, it is possible to arrange the detection regions E1 to E5 of the pyroelectric elements 16a to 16e to overlap as shown in FIG. 22. The detection region of each of the pyroelectric elements 16a to 16e can be divided according to the configuration of the lens shape of the condensing lens placed immediately above each of the pyroelectric elements 16a to 16e, or alternatively, can also be divided by forming the pyroelectric elements 16a to 16e each from a plurality of elements.

The motion detector 1 shown in FIG. 22 can be configured such that, with a plurality of space regions S11 to S15 where an object such as a human body is detected being set around the motion detector, overlaps between the detection regions E1 to E5 of the pyroelectric elements 16a to 16e and the space regions S11 to S15 occur due to different pyroelectric elements 16a to 16e depending on the space regions S11 to S15. That is, in the space region S11, only the detection regions E1 and E2 of two pyroelectric elements 16a and 16b overlap while in the space region S12, the detection regions E1 to E3 of three pyroelectric elements 16a to 16c to which the pyroelectric element 16c is further added overlap. Moreover, in the space region S13, the detection regions E2 to E4 of three pyroelectric elements 16b to 16d overlap, and in the space region S14, the detection regions E3 to E5 of three pyroelectric elements 16c to 16e overlap. In the space region S15, the detection regions E4 and E5 of two pyroelectric elements 16d and 16e overlap.

The motion detector 1 of this embodiment not only can recognize the distance of an object in the detection regions E1 to E5 from the output signal of each of the pyroelectric elements 16a to 16e but also can precisely determine which of the space regions S11 to S15 the detected object is present in by the combination of the pyroelectric elements 16a to 16e because the overlaps between the space regions S11 to S15 with the detection regions E1 to E5 occur due to different combinations of the pyroelectric elements 16a to 16e depending on the space regions S11 to S15. It is possible to synergistically increase the number of space regions where determination can be made by increasing the number of divided detection regions of each light receiving element and also the number of light receiving elements, and thus dividing a large area that is the subject of detection into small portions enables highly precise detection to be performed. It is preferable to configure the overlaps of the detection regions E1 to E5 with the space regions S11 to S15 to occur near the distal ends of the detection regions E1 to E5, and thereby unintended overlaps of the detection regions E1 to E5 with each other are prevented, and it is thus possible to perform accurate motion detection.

Moreover, in the motion detector 1 of this embodiment, according to the curvature of the substrate 10, not only the relative positions and directions of the pyroelectric elements 16a to 16e change, but also the pyroelectric elements 16a to 16c themselves curve, thus making it possible to change the sizes of the detection regions E1 to E5. That is, it is possible to finely adjust the viewing angle and the resolving power in a continuous manner according to the bending angle, and it is possible to more promptly and easily achieve the desired combinations of the detection regions E1 to E5 described above than the case where a plurality of infrared sensors are separately placed. By retaining the substrate 10 and the condensing lens 20 so as to be apart in the thickness direction, the detection regions E1 to E5 are maintained in a favorable manner also when the substrate 10 is in a curved state.

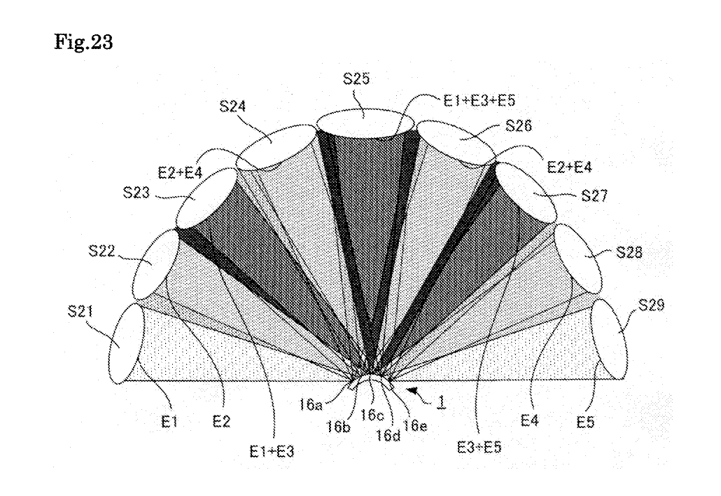

The curved shape of the motion detector 1 shown in FIG. 22 corresponds to the case where the space regions S11 to S15 are set to be apart from each other, and is suitable for detecting the flow or speed of people. On the other hand, in the case where space regions S21 to S29 are set so to have no gaps as shown in FIG. 23 for performing detection of the location of a human body or the like, the radius of curvature of the curved substrate 10 may be made bigger than that in the case of FIG. 22. Thus, changing the curved shape of the substrate 10 makes it possible to promptly and easily make an optimal setting according to, for example, the installation environment or the purpose. In order to make it possible to detect, for example, a human body in a stationary state, the motion detector 1 may be suitably provided with a chopper that blocks the detection regions E1 to E5 of the pyroelectric elements 16a to 16e.

In FIG. 23, overlaps of the detection regions E1 to E5 due to the combinations of the plurality of pyroelectric elements 16a to 16e do not necessarily need to occur in all the set space regions S21 to S29, and may occur only in some of the space regions S21 to S29. For example, in the space regions S21, S22, S28, and S29, there is only a single detection region E1, E2, E4, or E5. In this case as well, overlaps of detection regions (for example, E1 and E3, and E2 and E4) occurring in other space regions (for example, S23 and S24) make it possible to determine the aforementioned space regions. That is, as long as the overlaps between the space regions S21 to S29 and the detection regions E1 to E5 occur due to different pyroelectric elements 16a to 16e for each of the space regions S21 to S29, the overlaps may result from a single pyroelectric element among 16a to 16e. Moreover, the pyroelectric elements 16a to 16e that cause the overlaps between the space regions S21 to S29 and the detection regions E1 to E5 to occur do not necessarily need to be different for all space regions S21 to S29. For example, in both space regions S24 and S26, the overlap of the detection regions E2 and E4 occurs due to the combination of the same pyroelectric elements 16b and 16d, and determination can be made from, for example, detection status in adjacent space regions.

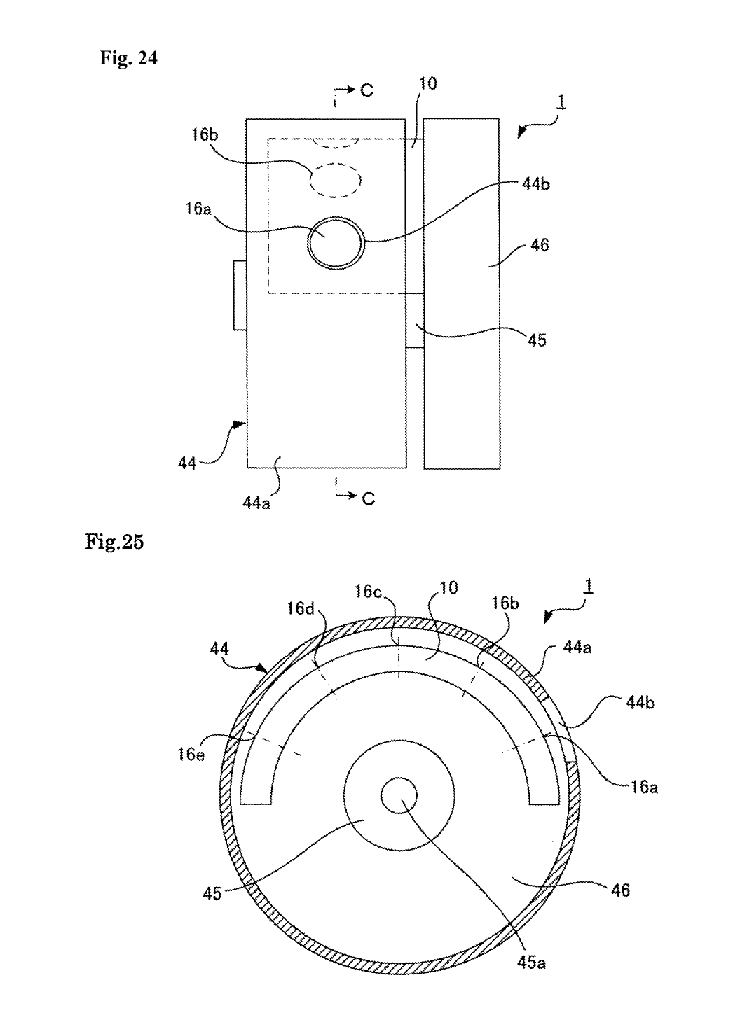

FIG. 24 is a side view showing one embodiment of the motion detector 1 in which the curved substrate 10 is accommodated in a chopper 44, and FIG. 25 is a cross-sectional view taken along the line C-C in FIG. 24. As shown in FIGS. 24 and 25, the substrate 10 curved into a semicircular shape as viewed from the side is fixed to the surface of a retaining block 46 together with a drive motor 45. The chopper 44 is formed into the shape of a cylinder having a cover, a rotational shaft 45a of the drive motor 45 is connected to the center of the cover, and thus the chopper is rotatably supported. A side wall 44a of the chopper 44 is formed along the curved shape of the substrate 10 such that the gaps between the pyroelectric elements 16a to 16e of the motion detector 1 are constant, and has an opening 44b that is substantially the same size as the pyroelectric elements 16a to 16e in a position facing the pyroelectric elements 16a to 16e. According to this motion detector 1, the pyroelectric elements 16a to 16e can perform sensing only when they overlap the opening 44b due to the rotation of the chopper 44, and thus infrared rays that enter the pyroelectric elements 16a to 16e are chopped. Therefore, detection can be reliably made even when a human body or the like is stationary in the detection regions E1 to E5, and its position can be specified. Only one opening 44b is provided in this embodiment, but a plurality of openings may be provided. Other than this configuration, the motion detector 1 comprising the chopper 44 is applicable to other configurations having the curved substrate 10.

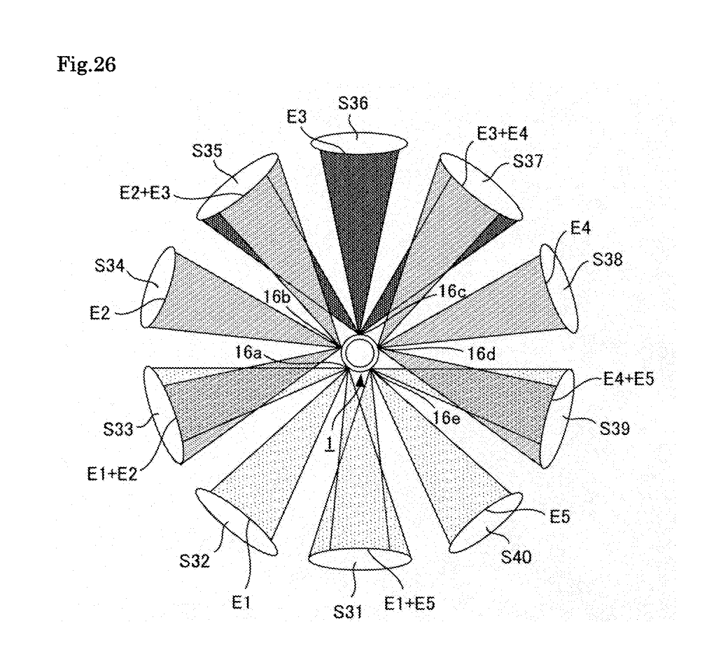

In the embodiments shown in FIGS. 22 and 23, the substrate 10 of the motion detector 1 is curved into a rounded shape as viewed from the side, but as shown in FIG. 26, the substrate 10 may be curved into a circular shape as viewed from the side and placed so as to have a viewing angle of 360 degrees. According to this configuration, for all set space regions S31 to S40, there is a single detection region among E1 to E5, or overlaps of the detection regions E1 to E5 due to combinations of two of the pyroelectric elements 16a to 16e are obtained, and the flow of people in any direction can be detected.

In addition, the curved shape of the substrate 10 is not particularly limited, for example, the substrate 10 may have a wavy shape, an elliptical shape, or a polygonal shape such as a trapezoidal shape as viewed from the side, and can have any shape such that the desired overlaps of detection regions occur in the set space regions. Moreover, the substrate 10 may be curved only partially, e.g., at the tip. Although the pyroelectric elements 16a to 16e are arranged in-line in the motion detector 1 of this embodiment, the pyroelectric elements may be in another arrangement such as a matrix form or a radial form. For example, bending a casing that accommodates light receiving elements arranged in a matrix form into a spherical shape makes it possible to planarly expand detection regions, thus enabling detection to be performed over a large area.

In the above embodiments, a human body is particularly suitable as a detection target object, and it is also possible to detect other objects that undergo a change in quantity of heat (for example, hot water, gas such as CO₂ or NOx, ink particles, and the like). The output signal of the signal processor 40 need only be substantially constant at least in the 0.5 to 10 Hz frequency band, and the frequency band may be suitably expanded according to the detection target object. In particular, when the signal processor 40 comprises a detection circuit of a current readout type, the output signal can be maintained substantially constant up to a high frequency of about 1 kHz, and it is thus possible to broaden the applicable frequency band.

### REFERENCE SIGNS LIST

1. Motion detector

10. Substrate

16 (16a to 16e). Pyroelectric element

22. Narrow-field lens

30. Casing

321. Slit

40. Signal processor

41. FET

42. Reference resistor

45. Operational amplifier

46. Reference resistor

50. Support

60. Light source

1. A motion detector comprising:
a substrate on a surface of which a plurality of pyroelectric elements for detecting infrared light emitted from an object are placed at intervals,
a detection circuit for converting an input signal from each pyroelectric element into a voltage signal to output the voltage signal, and
a determination means for comparing the output signal of the detection circuit with a preset reference value to determine whether or not there is a motion of the object in detection regions that are set within predetermined detection distances from the pyroelectric elements, wherein
the output signal of the detection circuit is configured to be constant in a set frequency band, and
the motion detector further comprises a movement information calculating means for calculating movement information containing information on a distance to the object and a direction of movement of the object determined by the determination means.

2. The motion detector according to claim 1, wherein the pyroelectric elements constitute a plurality of sensor groups classified according to sizes of the detection distances, and
the detection regions of the pyroelectric elements are placed such that the detection regions of the pyroelectric elements included in the same sensor group overlap while the detection regions of the pyroelectric elements between different sensor groups do not overlap.

3. The motion detector according to claim 2, wherein the pyroelectric elements constituting one of the sensor groups are placed at an equal distance from a predetermined detection position that is on an imaginary straight line extending in toward and away from the substrate such that the detection regions overlap at the detection position.

4. The motion detector according to claim 3, wherein the substrate comprises a plurality of strip-like objects on which the pyroelectric elements are linearly placed and which are curved into a rounded shape, and
the strip-like objects radially extend, with a position of intersection with the imaginary straight line being a center.

5. The motion detector according to claim 2, wherein at least a pair of the pyroelectric elements included in any of the sensor groups output signals of mutually reverse polarities.

6. The motion detector according to claim 1, further comprising a light source for outputting modulated light modulated to a predetermined frequency, wherein
the movement information calculating means distinguishes the modulated light detected by the pyroelectric elements from infrared light emitted from the object and obtains information contained in the modulated light.

7. The motion detector according to claim 1, wherein
the pyroelectric elements are configured such that:
the detection region of each pyroelectric element is divided into a plurality of portions, and
the detection region of any of the pyroelectric elements respectively overlaps, near its distal end, a plurality of preset space regions; and
an overlap between the space region and the detection region occurs due to a different pyroelectric element depending on the space region.

8. The motion detector according to claim 7, wherein three or more pyroelectric elements are placed on the substrate, and
the overlap between the space region and the detection region occurs due to a different combination of the pyroelectric elements depending on the space region.

9. The motion detector according to claim 1, further comprising a chopper that has an opening with substantially the same size as the pyroelectric elements in a cylindrical side wall and is rotatable by a drive means, wherein
the substrate is accommodated in the chopper and curved along an inner surface of the side wall.

10. The motion detector according to claim 1, wherein the pyroelectric elements are placed such that the detection regions do not overlap each other.
